(19) United States
(12) Patent Application Publication
(10) Pub. No.: US 2026/0034871 A1
(43) Pub. Date: Feb. 5, 2026

(54) WIND DEFLECTOR FOR A VEHICLE SUNROOF SYSTEM

(71) Applicant: Roof Systems Germany GmbH, Dietzenbach (DE)

(72) Inventors: Justus BOETTCHER, Dietzenbach (DE); Ahmet Hilmi TEKIN, Dietzenbach (DE); Matthias HELK, Dietzenbach (DE)

(21) Appl. No.: 19/099,868

(22) PCT Filed: Aug. 3, 2023
(86) PCT No.: PCT/EP2023/071574

§ 371 Date: Jan. 30, 2025

(30) Foreign Application Priority Data
Aug. 3, 2022 (DE) 20 2022 104 414.7

(51) Int. Cl. B60J 7/22

(52) U.S. Cl. CPC B60J 7/22

(57) ABSTRACT

A wind deflector for a vehicle sunroof system includes a vehicle-fixed bearing component, a raising lever which is mounted at a bearing end so as to be displaceable on the bearing component in a guide, a raising spring which has a spring arm having one end rotatably mounted on the bearing component and the other end rotatably mounted on the raising lever at that end thereof which faces away from the bearing end, and a latching structure. The latching structure is between the bearing component and the bearing end when the raising lever is in a raised position.

The present disclosure relates to a wind deflector for a vehicle sunroof system.

### BACKGROUND

The function of the wind deflector is to improve the flow conditions when a lid of a sunroof system is in an open position in which a roof opening is released. The wind deflector is usually arranged on the front edge of the roof opening, as viewed in the direction of travel of the vehicle, so that it can be moved between a raised and a lowered position. In the lowered position, the wind deflector is located below the outer surface of the vehicle roof. In the raised position, a raising lever projects from the outer surface of the vehicle roof. In this position, the flow conditions when the lid of the sunroof is open are influenced in a favorable manner. On the one hand, vehicle occupants are less exposed to a direct flow, and on the other hand, vibrations are prevented which are perceived by vehicle occupants as a booming, i.e. as a low-frequency noise.

One type of wind deflector has as its wind deflector element a flexible net or fabric which has one end firmly attached to the vehicle and the other end attached to the raising lever. The advantage of such a net wind deflector is that the wind deflector element can be stored in a very space-saving manner on the vehicle when the raising lever is in the lowered position. Furthermore, the net wind deflector is very effective at preventing booming noises.

However, net wind deflectors have the problem that a flow acting on the wind deflector element tries to move the raising lever downwards towards the vehicle roof. This impairs the efficiency of the wind deflector. But even with wind deflectors using rigid wind deflector elements, there is a risk that at higher driving speeds, the applied flow move them downwards from the maximum raised position.

Therefore, there is a need to provide a wind deflector which is characterized by a simple structure and in which it is ensured that the raising lever remains reliably in the fully raised position even at higher driving speeds.

### SUMMARY

An example embodiment discloses a wind deflector for a vehicle sunroof system is provided according to the invention, comprising a vehicle-fixed bearing component, a raising lever which is mounted at a bearing end so as to be displaceable on the bearing component in a guide, a raising spring which has a spring arm having one end rotatably mounted on the bearing component and the other end rotatably mounted on the raising lever at that end thereof which faces away from the bearing end, a latching structure being provided, which is effective between the bearing component and the bearing end when the raising lever is in the raised position. The present disclosure is based on the basic idea of locking the end of the raising lever that is displaceably mounted on the bearing component by means of the latching structure when the raising lever is in the fully raised position. The latching structure by means of which an elastic latching force is generated, makes this possible with little design effort.

According to one example embodiment, it is provided that the latching structure has a spring on the bearing component which cooperates with the bearing end of the raising lever. The spring may be designed with little effort in a suitable manner on the bearing component.

According to one example embodiment, it is provided that the spring is a spring element formed integrally with the bearing component. The particular advantage of this example embodiment is that no effort is required to assemble a separate spring; instead, geometric features such as spring arms or spring projections may be provided on the bearing component with little effort.

According to an alternative example embodiment, it is provided that the spring is a separate component attached to the bearing component. The particular advantage of this embodiment is that a particularly suitable material, in particular spring steel, may be used for the spring.

The spring may be injected-molded into the bearing component, so there is no need to mount it separately afterwards.

The latching structure may include a latching projection provided on the spring to produce high latching forces which hold the raising lever in the fully raised position.

The latching structure may also have a latching projection which is arranged on the bearing component and is in particular integrally connected thereto. The latching projection is arranged so as to cooperate with the raising lever when it is in its fully raised position.

According to one example embodiment, it is provided that the bearing end of the raising lever is provided with a latching surface which is arranged concentrically with respect to the pivot axis of the bearing end. In this example embodiment, the latching force generated between the latching surface and a spring or a latching projection is independent of the position of the raising lever.

According to an alternative example embodiment, the bearing end is provided with a latching arm having a latching surface at its free end. In this example embodiment, the position of the latching surface changes when the raising lever is pivoted. This can be used to generate higher latching forces when the raising lever is in the fully raised position.

According to one example embodiment, it is provided that a latching spring which cooperates with a latching projection on the bearing component is provided at the bearing end of the raising lever. This design also allows the desired latching forces to be generated with little effort.

According to one example embodiment, it is provided that the guide is a sliding guide which has a guide slot on the bearing component and a sliding element on the raising lever. This results in a particularly space-saving design.

If the latching structure has a latching projection on the bearing component or a spring arranged thereon, the latching projection preferably projects into the displacement path of the sliding element. In this embodiment, the latching forces generated are applied directly to the sliding element, thus preventing it from being displaced in the sliding guide.

It may also be provided that the latching surface is designed separately from the sliding element and concentrically with the center axis thereof, so that it can in particular be designed with a larger radius than the sliding element. This reduces the surface pressure which acts locally when the latching surface cooperates with a latching projection.

If the bearing end is provided with a latching arm, the latching surface is preferably arranged on that side of the sliding element which faces away from the raising end of the raising lever. When the raising lever is moved to the fully raised position, the latching surface then enters a position below the sliding element where it can cooperate with a latching projection.

According to an alternative example embodiment, the guide is a sliding guide having a guide slot on the raising lever and a sliding element on the bearing component. The raising lever can also be reliably guided with this distribution of the guide slot and the sliding element.

In one example embodiment, it may then be provided that a latching nose is provided at the bearing end of the raising lever, which cooperates with a latching spring on the bearing component. This results in a long lever arm for the latching forces introduced by the latching nose relative to the sliding element.

A deflector net may be attached to the raising lever, so that a low overall height is achieved when the raising lever is in the lowered state.

### BRIEF DESCRIPTION OF THE DRAWINGS

The present disclosure will be described below on the basis of various embodiments, which are illustrated in the accompanying drawings in which:

FIG. 1 shows in a schematic side view a wind deflector with a raising lever in the lowered state;

FIG. 2 shows the wind deflector of FIG. 1 with the raising lever in the nearly fully raised position;

FIG. 3 shows the example embodiment of FIGS. 1 and 2 in a perspective and enlarged view, only the bearing end of the raising lever and the associated area of the bearing component being shown, and the raising lever being in the raised position;

FIG. 4 shows a section through the bearing end and the guide of FIG. 3;

FIG. 5 shows a schematic sectional view of a second example embodiment, only the bearing end of the raising lever and the associated area of the bearing component being shown, the raising lever being in the lowered position;

FIG. 6 shows a view corresponding to that of FIG. 5, the raising lever being in the raised position;

FIG. 7 shows a third example embodiment in a side view, only the bearing end of the raising lever and the associated area of the bearing component being shown, and the raising lever being in the lowered position;

FIG. 8 shows the bearing end of FIG. 7, the raising lever being in the raised position;

FIG. 9 shows a fourth example embodiment in a side view, only the bearing end of the raising lever and the associated area of the bearing component being shown, and the raising lever being in the lowered position;

FIG. 10 shows the bearing end of FIG. 9, the raising lever being in the raised position;

FIG. 11 shows a fifth example embodiment in a perspective view, only the bearing end of the raising lever together with the associated area of the bearing component being shown, and the raising lever being in the lowered position;

FIG. 12 shows the bearing end of FIG. 11, the raising lever being in the raised position;

FIG. 13 shows a sixth example embodiment in a schematic sectional view, only the bearing end of the raising arm together with the associated area of the bearing member being shown, and the raising lever being in the lowered position; and

FIG. 14 shows the bearing end of FIG. 13, the bearing arm being in the raised position.

### DETAILED DESCRIPTION

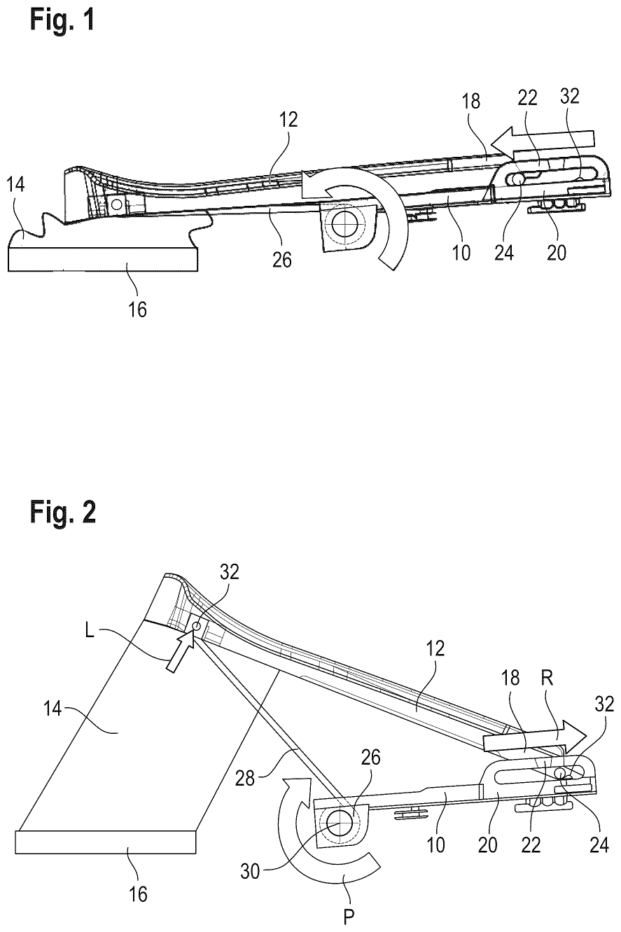

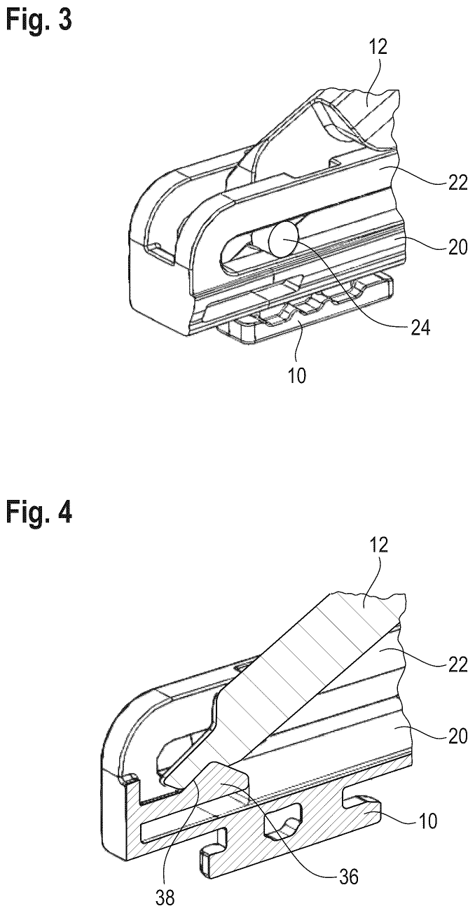

FIGS. 1 through 4 show a wind deflector for a vehicle sunroof system. The vehicle sunroof system is part of a motor vehicle and includes a lid which is movable between an open position and a closed position. The wind deflector is associated with the front edge of the opening of the vehicle roof which can be closed or opened by the lid.

The wind deflector has a bearing component 10 which is attached in a vehicle-fixed manner. A raising lever 12 which can be moved between a lowered position (see FIG. 1) and an raised position is attached to the bearing component 10. A wind deflector element 14 which is a deflector net here is attached to the front end of the raising lever 12, as seen in the direction of travel. The lower edge of the deflector net is attached to the vehicle, for example to a frame 16 which is part of the sliding roof system.

The raising lever 12 has a bearing end 18 which is slidably and pivotally received in a bearing section 20 of the bearing member 10 by means of a guide.

In a plan view, the raising lever 12 has a generally U-shaped configuration, only the two short side legs of the U-shaped configuration being visible in FIGS. 1 and 2. The crossbar which extends along the edge of the opening in the vehicle roof is not visible here. As the two legs of the raising lever 12 are mounted in the same way on the vehicle roof, only one of the two bearing components 10 used on the vehicle will be described below.

In the example embodiment shown, the guide is a sliding guide which is formed by a guide slot 22 on the bearing component 10 and a sliding element 24 on the bearing end 18 of the raising lever 12.

The wind deflector element 14 is attached to the end of the raising lever 12 which faces away from the bearing end 18. It extends across the entire width (i.e. the crossbar) of the raising lever 12 and laterally over part of the side legs of the raising lever 12 to the bearing end 18.

A raising spring 26 is attached to the bearing component 10 in front of the guide 22, 24, as seen in the direction of travel. It is here a bow spring, one arm of which is firmly supported on the bearing component 10 and the other arm of which is a spring arm 28, which has one end supported on a pivot point 30 on the bearing component 10 and the other end connected to the raising lever 12 at a pivot point 32. The pivot point 32 is located in the vicinity of the end of the raising lever facing away from the guide 22, 24, i.e. close to the front edge in the area of the wind deflector element 14.

The spring arm 28 of the raising spring 26 is acted upon in the direction of the arrow P of FIG. 2, so that it acts upon the front edge of the raising lever 12 in the direction of the arrow L of FIG. 2, thus pushes it upwards. The raising lever 12 then performs this movement when the sunroof lid is moved to the open position. During the movement from the closed position to the raised position, the sliding element 24 moves within the guide slot 22 in the direction of the arrow R in FIG. 2.

When the sunroof lid is closed, the raising lever 12 moves in the opposite direction, as indicated by the arrow in FIG. 1.

A latching structure is provided to ensure that the raising lever 12 remains in the raised position even when a wind load acts on the wind deflector element 14.

In the embodiment shown in FIGS. 1 to 4, the latching structure is formed by a spring 36 which is provided on the bearing section 20 of the bearing component 10. The spring 36 is designed here as a leaf spring-like spring element which is integrally connected to the bearing component 10 at one end and has a latching nose at the other end.

The bearing end of the raising lever 12 has a latching arm which projects beyond the sliding element 24 and at the free end of which a latching surface 38 is provided.

As the latching surface 38 is located on the other side of the sliding element 24, it is pivoted downwards when the raising lever 12 is pivoted into the fully raised position. As the sliding element 24 is also at the end of the sliding path defined by the guide slot 22 near the completely raised position, it then comes into engagement with the spring 36 or engages behind the latching projection provided on the spring. This prevents the raising lever 12 from being inadvertently moved downwards when wind loads act on the wind deflector element 14.

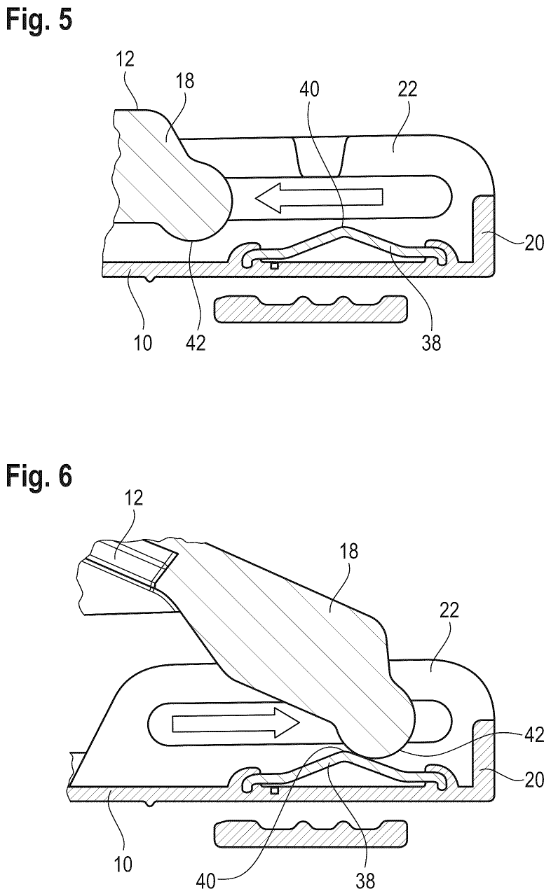

A second embodiment is shown in FIGS. 5 and 6. The same reference numerals are used for the components and features known from the previous embodiment, and in this respect, reference is made to the above explanations.

In the second embodiment, the latching structure includes a spring 38 in the form of a leaf spring which is designed as a separate component and attached to the bearing section 20 of the bearing component 10.

In the example embodiment shown, the spring 38 is injection-molded into the bearing section 20.

As can be seen in the figures, the spring 38 is designed in the form of a bow, the ends facing away from each other being embedded in the material of the bearing section 20 of the bearing component 10. The spring has a latching projection 40 approximately in the center.

The bearing end 18 of the raising lever 12 is provided here with a latching surface 42 which is concentric with the sliding element 24 (not visible in this illustration). The latching surface 42 has a larger diameter than the sliding element 24.

When the raising lever 12 is moved to the fully raised position, the latching surface 24 slides over the latching projection 40 of the spring 38 into the position shown in FIG. 6. The bearing end 18 of the raising arm 12 is elastically fixed there so that wind loads acting on the wind deflector element 14 cannot push the raising lever 12 downwards from the fully raised position.

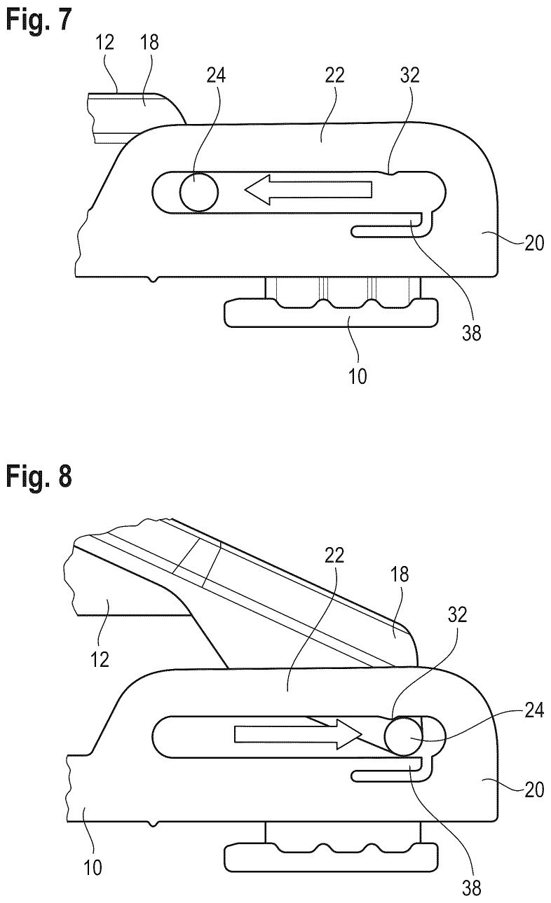

A third embodiment is shown in FIGS. 7 and 8. The same reference numerals are used for the components and features known from the previous embodiments, and in this respect, reference is made to the above explanations.

In the third embodiment, a latching projection 32 is provided within the displacement path defined by the guide slot 22. It is arranged on one side of the guide slot 22, while a spring 38 is provided on the opposite side.

The spring 38 is here designed integrally with the bearing component 10, wherein it has the shape of a leaf spring which is connected at one end to the bearing component 10 and is otherwise freely cantilevered.

The spring 38 allows the sliding element 24 to move “behind” the latching projection 32 when the raising lever 12 is pivoted to the fully raised position.

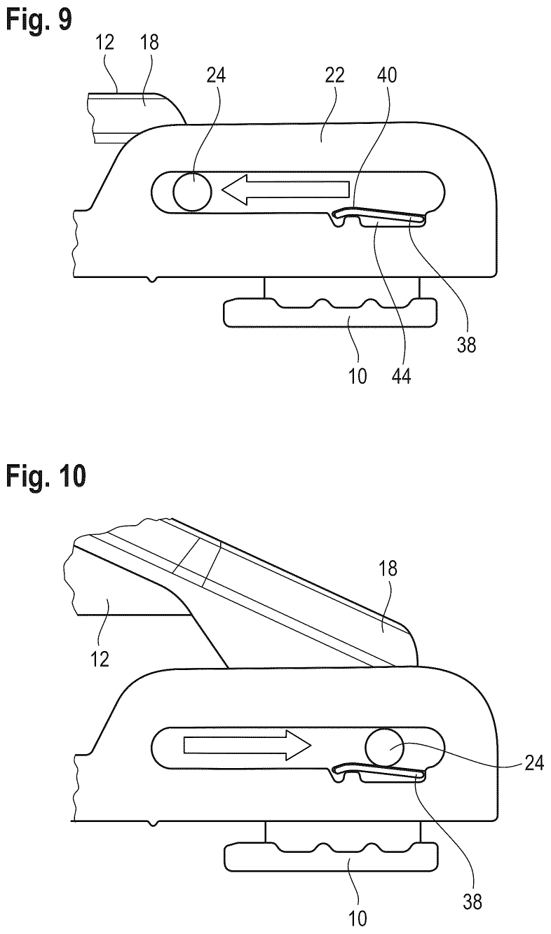

A fourth embodiment is shown in FIGS. 9 and 10. The same reference numerals are used for the components and features known from the previous embodiments, and in this respect, reference is made to the above explanations.

In the fourth embodiment, a spring 38 is used as the latching structure, which is designed here as a separate component and is inserted into a recess 44 in the area of the guide slot 22. The spring 38 is curved so that it defines a latching projection 40. The latter cooperates with the sliding element 24 when it is pushed out of the area of the displacement path shown on the left in the figures and into the area shown on the right.

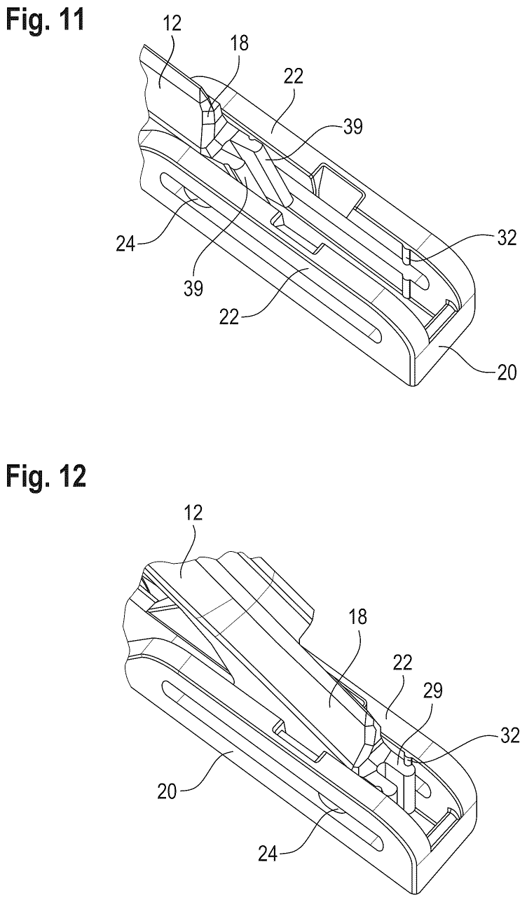

A fifth embodiment is shown in FIGS. 11 and 12. The same reference numerals are used for the components and features known from the previous embodiments, and in this respect, reference is made to the above explanations.

In the fifth embodiment, two latching springs 39 are provided at the bearing end 18 of the raising lever 12, which have a width greater than their length, in the manner of latching webs. The latching springs 39 cooperate with two latching projections 32 assigned to the guide slot 22. In contrast to the latching projections of the previous embodiments, the latching projections 32 in the fifth embodiment are not arranged within the displacement path of the sliding elements 24, but rather within the free space for the bearing end 18 of the raising lever 12.

When the raising lever 12 is pivoted into its fully raised position, the latching springs 39 come into engagement with the latching projections 32, wherein, due to the pivoting movement of the bearing end 18 and the width of the latching springs 39, the latter do not slide in a translational manner over the latching projections 32, but are displaced in a combination of a pivoting and sliding movement. As a result, the holding forces provided by the latching structure in the state shown in FIG. 12 are greater than the forces required to bring the bearing end 18 into the position shown in FIG. 12.

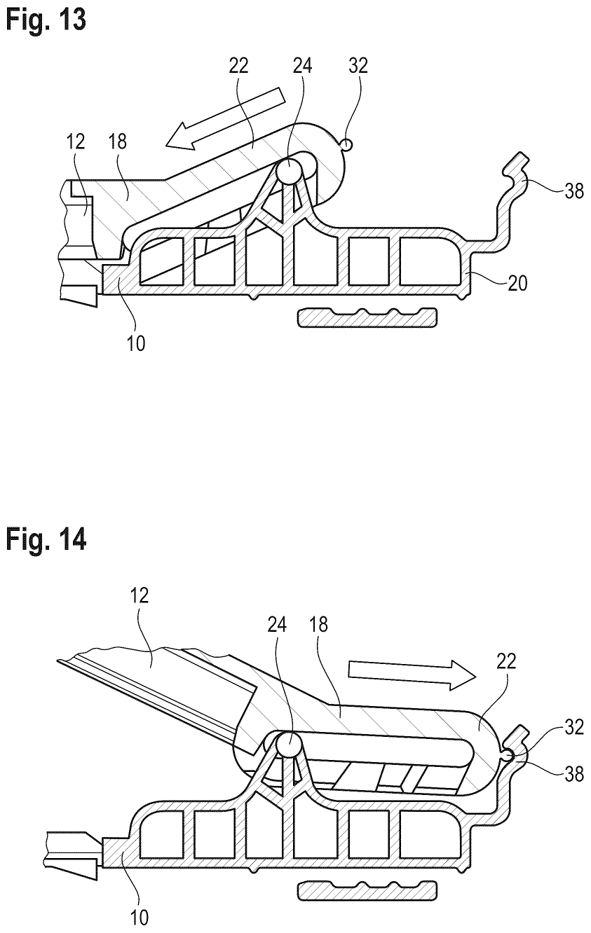

FIGS. 13 and 14 show a sixth embodiment. The same reference numerals are used for the components and features known from the previous embodiments, and in this respect, reference is made to the above explanations.

In contrast to the previous embodiments, the sliding element 24 in the sixth embodiment is arranged in a fixed manner on the bearing component 10. In contrast thereto, the guide slot 22 is assigned to the bearing end 18 of the raising lever 12.

The bearing component 10 is provided here with a spring 38 which can cooperate with a latching projection 32 attached to that end of the raising lever 12 which faces away from the wind deflector element 14.

In the fully raised position, as shown in FIG. 14, the latching projection 32 latches onto the spring 38. This prevents the raising lever 12 from being moved downwards out of the fully raised position when wind loads act on the wind deflector element 14.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A wind deflector for a vehicle sunroof system, comprising:
a vehicle-fixed bearing component,
a raising lever which is mounted at a bearing end so as to be displaceable on the bearing component in a guide,
a raising spring which has a spring arm having one end rotatably mounted on the bearing component and the other end rotatably mounted on the raising lever at that end thereof which faces away from the bearing end, and
a latching structure, which is effective between the bearing component and the bearing end when the raising lever is in a raised position.

2. The wind deflector of claim 1, wherein the latching structure has a spring on the bearing component which cooperates with the bearing end of the raising lever.

3. The wind deflector of claim 2, wherein the spring is a spring element formed integrally with the bearing component.

4. The wind deflector of claim 2, wherein the spring is a separate component which is attached to the bearing component.

5. The wind deflector of claim 4, wherein the spring is injection-molded into the bearing component.

6. The wind deflector of claim 2, wherein the latching structure has a latching projection which is provided on the spring.

7. The wind deflector of claim 1, wherein the latching structure has a latching projection which is arranged on the bearing component and is in particular integrally connected thereto.

8. The wind deflector of claim 1, wherein the bearing end of the raising lever is provided with a latching surface which is arranged concentrically with respect to the pivot axis of the bearing end.

9. The wind deflector of claim 1, wherein the bearing end is provided with a latching arm which has a latching surface at its free end.

10. The wind deflector of claim 1, wherein a latching spring is provided at the bearing end of the raising lever and cooperates with a latching projection on the bearing component.

11. The wind deflector of claim 1, wherein the guide is a sliding guide which has a guide slot on the bearing component and a sliding element on the raising lever.

12. The wind deflector of claim 11, wherein the latching structure has a latching projection which is provided on the spring, the latching projection projecting into the displacement path of the sliding element.

13. The wind deflector of claim 11, wherein the bearing end of the raising lever is provided with a latching surface which is arranged concentrically with respect to the pivot axis of the bearing end, the latching surface being formed separately from the sliding element and concentrically with the center axis thereof.

14. The wind deflector of claim 11, wherein the bearing end is provided with a latching arm which has a latching surface at its free end, the latching surface being arranged on that side of the sliding element which faces away from the raising end of the raising lever.

15. The wind deflector of claim 1, wherein the guide is a sliding guide having a guide slot on the raising lever and a sliding element on the bearing component.

16. The wind deflector of claim 1, wherein a latching nose cooperating with a latching spring on the bearing component is provided at the bearing end of the raising lever.

17. The wind deflector of claim 1, wherein a wind deflector element, in particular a wind deflector net, is attached to the raising lever.
